(19) United States
(12) Patent Application Publication
(10) Pub. No.: US 2026/0211548 A1
(43) Pub. Date: Jul. 23, 2026

(54) DISPLAY APPARATUS AND METHOD FOR OPERATING SAME

(71) Applicant: Continental Automotive Technologies GmbH, Hannover (DE)

(72) Inventors: Jochen MÖLLER, Darmstadt (DE); Andreas KLAR, Hainburg (DE)

(21) Appl. No.: 19/140,148

(22) PCT Filed: Nov. 2, 2023
(86) PCT No.: PCT/DE2023/200222

§ 371 Date: Jun. 17, 2025

(30) Foreign Application Priority Data
Dec. 22, 2022 (DE) 10 2022 214 293.4
May 30, 2023 (DE) 10 2023 205 050.1

(51) Int. Cl. G06F 3/0488; G06F 3/0482; G06F 3/0484

(52) U.S. Cl. CPC G06F 3/0488; G06F 3/0482; G06F 3/0484; G06F 2203/04803; G06F 2203/04806

(57) ABSTRACT

A display apparatus having a main display element for high-resolution display, and an invisible control panel having a selection display element with touch function which has a lower resolution than the main display element.

### CROSS REFERENCE TO RELATED APPLICATIONS

This is a U.S. national stage of Application No. PCT/DE2023/200222 filed Nov. 2, 2023. Priority is claimed on German Application No. DE 10 2022 214 293.4 filed Dec. 22, 2022, and German Application No. DE 10 2023 205 050.1 filed May 30, 2023, the contents of which are incorporated herein by reference.

### BACKGROUND OF THE INVENTION

### 1. Field of the Invention

The present disclosure relates to a display apparatus, in particular with an invisible control panel, and to a method for the operation thereof.

### 2. Description of the Related Art

US 2017/024 106 A1 relates to a user interface with adaptation of a display. The display on a display element is here split on the basis of a long press on a region within the display element. Horizontal splitting of the display takes place at the point at which a user has positioned the long press. Selection of a display window that is to be displayed in a region of the split display is effected by selection of an icon as a result of a user touching the icon on the display element. Assignment to the desired region of the split display is effected by dragging the icon into that region while continuing to touch it. Confirmation of the assignment is effected by terminating touching, that is to say by releasing the icon in that region. It is to be considered a disadvantage that the user is able to select only the regions of the display element that he can touch from his viewing position.

US 2016 046 188 A1 relates to an information reproduction system. A display is here split not by a long press but by touching an icon displayed on a display element, dragging the icon to a desired point of the display element, while continuing to touch it, and releasing the icon at that point (also referred to as “drag-and-drop”). Here too, the user is able to select only the regions of the display element that he can reach and touch from his viewing position.

CN 106 959 831 A relates to a display element with a split screen. Switching of the split screen is effected by a long press in the region of the screen that it is desired to display on an enlarged scale. Here too, the user is able to select only the regions of the display element that he can reach and touch from his viewing position.

US 6,008,809 A discloses a display apparatus with a split screen, in which the size of display windows is adjusted dynamically. If the size of a display window falls below a minimum size, it is replaced by an icon. US 2020/0356427 A1 relates to a split screen in which the size of display windows can be changed by moving a touch point of a plurality of display windows.

### SUMMARY OF THE INVENTION

A display apparatus that is improved relative thereto and an improved method for the operation thereof are desirable.

A display apparatus according to one aspect of the invention comprises a main display element for high-resolution display, and a disappearance technology control panel having a selection display element with touch function which has a lower resolution than the main display element. This has the advantage that the user, by the selection display element, is also able to select the regions of the main display element that he cannot reach and touch from his viewing position. The main display element can be very wide or can be arranged so far in front of the user that it would be impossible or awkward for the user to reach the entire area thereof with his finger in order to make a selection there. The selection display element is arranged closer to the user and is therefore easier to reach. Advantageously, the main display element is not soiled by fingerprints, which are unavoidable in the case of a touchscreen function. It retains its high brilliancy. A negative impact resulting from fingerprints is less of a problem on the selection display element.

According to one configuration, it is provided that the main display element is a display element that displays in color, and the selection display element is a display element that displays with a lower color resolution or in one color. This has the advantage that such a selection display element can be realized without a great outlay as a disappearance technology control panel, also referred to as an invisible control panel. In this case, great effort does not have to be expended in respect of color fastness or color change by the surface layer of the disappearance technology control panel.

According to one configuration, it is provided that the selection display element has a smaller extent than the main display element. Operation by the user is particularly comfortable if his hand does not have to make large movements in order to reach all areas of the selection display element.

According to one configuration, it is provided that the selection display element is arranged beneath the main display element. This has the advantage that the user does not need to lift his hand particularly high in order to be able to touch the selection display element.

It is particularly advantageous if
the main display element has such an extent and is so arranged with respect to a designated viewing position that a viewer is not able to reach every part of the display area of the main display element with one of his fingers from the designated viewing position, and at the same time
the selection display element has such an extent and is so arranged with respect to a designated viewing position that a viewer is able to reach every part of the display area of the selection display element with one of his fingers from the designated viewing position. In particular the horizontal extent of the main display element can be designed to be particularly large.

A development of a display apparatus according to the invention comprises a control device and a memory in which information about priority image elements or about priority and subordinate image elements is stored. This has the advantage that, when reducing the size of image elements, the control device is able to access the information stored in the memory about the priority of an image element to be displayed. An image element with high priority is then displayed or changed differently to an image element with lower priority when its size is reduced. Preferably, there is information both about image elements that are stored in an unchangeable manner in the memory and about image elements that are changeable. The former is, for example, information concerning the safety relevance of an image element. Such information should not be changeable or manipulatable. Other types of information, by contrast, are changeable. These can be updated or replaced by other information, for example as part of an update. This makes it possible, by updating information stored in the memory, also to update the behavior of the display apparatus and/or adapt it to the user.

A method according to one aspect of the invention for operating a display apparatus concerns a main display element, which is adapted to display a plurality of display windows side by side, and a selection display element, which is adapted to display a plurality of small representations of display windows that can be displayed on the main display element. This method includes:
detecting whether a touch of one of the representations lasts for a longer time period than a given first minimum time period,
classifying the corresponding representation as the selected representation,
reducing the size of at least one of the display windows currently displayed on the main display element, and
displaying a display window corresponding to the selected representation on the area of the main display element that has been freed up by the reduction in size.

Advantageously, contents on the main display element can be concertinaed but can also expand again without its being necessary to ensure that they can be reached by the finger of the user. Expansion is advantageously triggered by a long touch on a representation again. However, other possible ways of making a selection to remove a display window from the main display element, such as quickly double-tapping the corresponding representation, dragging the corresponding representation away upward or downward, can expediently be used here.

A method according to the invention for operating a display apparatus concerns a selection display element, which comprises a plurality of selection regions and is adapted to display a plurality of representations side by side. Said method includes: detecting whether a touch of a selection region assigned to a representation lasts for a longer time period than a given second minimum time period. If that is the case, the corresponding selection region is classified as the selected selection region. Subsequently, the size of at least one of the representations currently displayed on the selection display element is reduced, and then the representation corresponding to the selected selection region is displayed on the area of the selection display element that has been freed up by the reduction in size. The advantage according to the invention of the concertina effect when adding or removing display windows or representations can also be achieved when the selection display element is operated without an associated main display element.

In contrast to solutions in which the external dimensions of a plurality of display windows are changeable but the displayed contents remain constant in terms of their size, it is provided according to the invention to dynamically adjust the displayed contents of at least one of the display windows in terms of size. As a result, the external dimension of the at least one display window also changes. It is provided that there are presets for the extent to which or the manner in which a display window is to be minimized. For example, there are types of display window that are reduced in size only to a specific minimum percentage, because a greater reduction in the size of the image contents displayed therein would limit them too greatly in terms of their recognizability. For example, there are types of display window, the contents of which are compressed in a specific preferential direction when they are reduced in size, that is to say are compressed horizontally, for example.

A method according to one aspect of the invention for operating a display apparatus concerns a selection display element, which is adapted to display a plurality of representations side by side. Said method includes:
detecting whether a touch of a selection region assigned to a representation lasts for a longer time period than a given second minimum time period,
classifying the corresponding selection region as the selected representation,
reducing the size of at least one of the representations currently displayed on the selection display element, and
displaying the selected representation on the area of the selection display element that has been freed up by the reduction in size.

Advantageously, contents on the selection display element can be concertinaed but can also expand again. Expansion is advantageously triggered by a long touch on a representation again or on a selection region assigned to the representation. However, other possible ways of making a selection to remove a representation from the selection display element, such as quickly double-tapping the corresponding representation or the selection region assigned thereto or dragging the corresponding representation away upward or downward, can expediently be used here.

Advantageously, for reducing the size of a display window currently displayed on the main display element, the vertical extent thereof is retained and the horizontal extent thereof is reduced. Correspondingly, for reducing the size of a representation currently displayed on the selection display element, the vertical extent thereof is retained and the horizontal extent thereof is reduced. This results in a concertina effect, which does not require excessively abrupt changes of the display and is thus easy for the user to follow and is scarcely or not at all irritating.

Advantageously, when the size of a display window or of a representation is reduced to below a given minimum size, at least one of the image elements displayed in that display window or that representation is replaced by a placeholder image element of reduced complexity or is removed from the display completely. This prevents the image elements from being excessively distorted, which would make them scarcely recognizable for the user. In this case, it is expedient to replace individual image elements by a placeholder image element which is of less complex form and thus, while taking up less space, is nevertheless easily recognizable for the user. If an image element is removed from the display completely, this creates space, so that other, remaining image elements can be displayed in a less greatly compressed manner. If space “becomes tight”, unimportant image contents thus drop out of the display.

Advantageously, when the size of the display windows or of the representations is reduced, the size of different display windows or representations is reduced to different extents. This has the advantage that information displays of high importance or those that are only poorly recognizable when their size is reduced to a greater extent are not reduced in size or are reduced in size only so slightly that they continue to be readily recognizable. For example, the size of a display window or of a representation containing information displays that are necessary for driving the vehicle is reduced to a lesser extent than those without such information displays.

Advantageously, priority image elements and subordinate image elements are specified. When the size of a display window or of a representation is reduced, the priority image elements displayed in that display window or in that representation retain their length-to-width ratio and/or their size, and at least one of the subordinate image elements is compressed in at least one direction or is replaced by a placeholder image element of reduced complexity or is removed from the display completely. This has the advantage that image elements that are relevant in terms of safety or that are often used remain unchanged and thus retain a high recognition value. This increases safety, in particular in the case of motor vehicle applications.

A development of a method according to the invention furthermore includes: detecting whether one of the representations or a selection region assigned to a representation is touched for a short, uninterrupted time period. If that is the case, classifying the corresponding representation as the representation selected as priority and replacing one or more of the display windows or representations that are currently being displayed by the display window assigned to the representation selected as priority or by the representation selected as priority. This has the advantage that an urgently required display is displayed by a quick but nevertheless unambiguous command without a great time lag and, as a result of the replacement of one or more of the display windows or representations that are currently being displayed, a large amount of space is also available for the display. Information that is desired as a priority is thus also displayed as a priority.

Advantageously, the relative arrangement of the image elements relative to one another is changed when the size is reduced. This makes it possible for a display window or a representation to be compressed in one direction without the shape and dimensions of the image elements contained therein likewise being compressed. Advantageously, only the gap between the individual image elements is reduced as a result of the changed relative arrangement, but not the shape or size of the image elements.

Advantageously, the display window or the plurality of display windows arranged between a display window displayed on the far left and a display window displayed on the far right is displayed on the main display element in accordance with the representation or the plurality of representations assigned thereto. This offers the advantage of a consistent display on the main and selection display elements. Potential misunderstandings by the user are reduced and safety is thus increased.

According to one aspect of the invention, it is possible to add any display windows or representations that are displayed on the selection display element, for example as a main or submenu point, to the main display element and/or the selection display element by a long press on a corresponding selection region or on a corresponding representation. A mixed display of display windows from different sources is also made possible. For example, these are an onboard climate display of a motor vehicle, which is executed on the operating system thereof, and, for example, a display of applications which are designed for execution on an operating system (e.g. Android) of a mobile device. According to the invention, it is possible for the content of the main display element and/or the content of the selection display element to be expanded or concertinaed. Advantageously, up to five additional display windows or representations are provided and can be added to the main display element and/or to the selection display element. In that case, the individual display windows or representations are not compressed too greatly that they would no longer be correctly perceived by the user. In addition, it is provided that the display windows or representations are compressed in terms of their content and behave “responsively”, that is to say such that less important image contents, for example, drop out of the display when space “becomes tight”.

A particularly expedient detail is the “concertina effect” which occurs when display windows or representations are added or removed. Advantageously, a so-called bounce effect is provided here, in which the expansion or compression does not take place with a constant speed and end abruptly, but takes place with a variable speed and an overshoot is additionally or alternatively also provided at the end of the expansion or compression. The display windows or representations are here initially compressed slightly further than would be necessary and leave the display window or representation that is to be added slightly more space than is necessary, and they then expand to the required extent again when the addition has taken place. This allows the user to better recognize the place at which the added element (display window or representation) is arranged. It is also easier in this case to recognize whether the operation of adding is still ongoing or is already complete. A similar procedure is provided in the case of removal, in which the remaining elements are first compressed, that is to say move apart from the element to be removed, and then assume their designated extent and their designated position on expansion. Here too, an overshoot, optionally with brief overlapping of individual display windows, is expediently provided. This too facilitates the intuitive understanding of the operation by the user.

The distribution concept of the screen contents is also advantageous. In accordance with a variant according to one aspect of the invention, only possibilities for controlling the main display element are offered on the selection display element with a simplified display. This is sometimes also referred to as “just controls”. In this case, the associated visualization takes place on the main display element. In this case, each element in the main display element has an associated control area in the selection display element, also in the case of the example with the concertina effect. Individual elements of the concertina can advantageously be removed from the chain again by closing the associated button.

According to a further aspect of the invention, a computer program comprises instructions which, when executed by a computer, cause the computer to carry out the steps for controlling a method according to the invention. The term computer is to be broadly understood. In particular, it also comprises control units, embedded systems, and other processor-based data processing devices. The computer program can be provided for electronic retrieval or can be stored on a computer-readable storage medium, for example.

There are many ways to interact with a display apparatus. The present invention solves the problem of dynamically splitting the area available for the display for a plurality of elements, display windows and representations that are to be displayed. Static possibilities for splitting these areas have been known hitherto. A plurality of sub-areas have fixed sizes. This is known from so-called smartphones or tablets. The available area can be split into two or more sub-areas. The content previously displayed on the undivided area is now displayed on one of these sub-areas. For the other, as yet unoccupied sub-areas, it is to be chosen what is to be displayed thereon. Increasingly large display elements are being installed in modern motor vehicles. The area available for display is thus also becoming increasingly larger. This makes it possible for more than two display windows to be displayed at the same time. With the present invention, it is possible to dynamically arrange a plurality of display windows in an individual manner. This is particularly advantageous in the case of particularly wide display apparatuses, such as those which extend from A-pillar to A-pillar in a motor vehicle.

Hitherto, only a small degree of flexibility has been provided in the case of display apparatuses in motor vehicles. Nevertheless, a greater distraction occurs on operation thereof than in the case of earlier systems with small display areas or with instruments to be operated individually. Hitherto, it has not been known to arrange contents for display according to one's wishes. According to the invention, it is possible in a dynamic manner to add additional display windows or to remove existing display windows from the current display.

By a long press on a selection region, the content associated with that region is according to the invention added to the contents that are currently being displayed. According to the invention, intuitive interaction with contents that are to be displayed and contents that are currently being displayed is achieved. In the case of large display areas that are available for display, in particular in the case of very wide display areas, the solution according to the invention results in less distraction for the user while at the same time offering better possibilities for display and interaction.

In an advantageous configuration, it is provided to display, in addition to the applications that are provided for the operating system of the motor vehicle, also applications that are provided for operating systems other than the operating system of the motor vehicle. Such applications can also be added to the contents that are currently being displayed. If there is no information as to how the contents of such applications are to be handled when their size is reduced, they are, for example, compressed both horizontally and vertically by default so that they are wholly visible even in the display window that has been reduced in size.

In an advantageous configuration, it is provided that, when a maximum number of simultaneously displayed windows or representations is reached, one of them is removed as soon as a further display window or a further representation is selected for display. For example, the display window that has already been displayed for longest or the display window with which there has been the least interaction in the last quarter of an hour is removed. Advantageously, there are provided types of display window that are removed only when a further condition is fulfilled, for example when there is feedback from a user, and other types of display window that may be removed unconditionally.

### BRIEF DESCRIPTION OF THE DRAWINGS

Further configurations of the invention and their advantages are also given in the following description of exemplary embodiments with reference to figures, in which:

FIG. 1 is a display apparatus;

FIG. 2 is a further display apparatus;

FIG. 3 is a further display apparatus;

FIG. 4 is a method;

FIG. 5 is a further method step;

FIG. 6 is a further method step;

FIG. 7 is a further method step;

FIG. 8 is a motor vehicle with a display apparatus;

FIG. 9 is sub-steps of a method; and

FIG. 10 is a selection display element

### DETAILED DESCRIPTION OF THE PRESENTLY PREFERRED EMBODIMENTS

For a better understanding of the principles of the present invention, embodiments of the invention are explained in more detail below with reference to the figures. Identical reference signs are used for identical or functionally identical elements in the figures and are not necessarily described again for each figure. It goes without saying that the invention is not restricted to the embodiments represented and that the features described may also be combined or modified without departing from the scope of protection of the invention as defined in the appended claims.

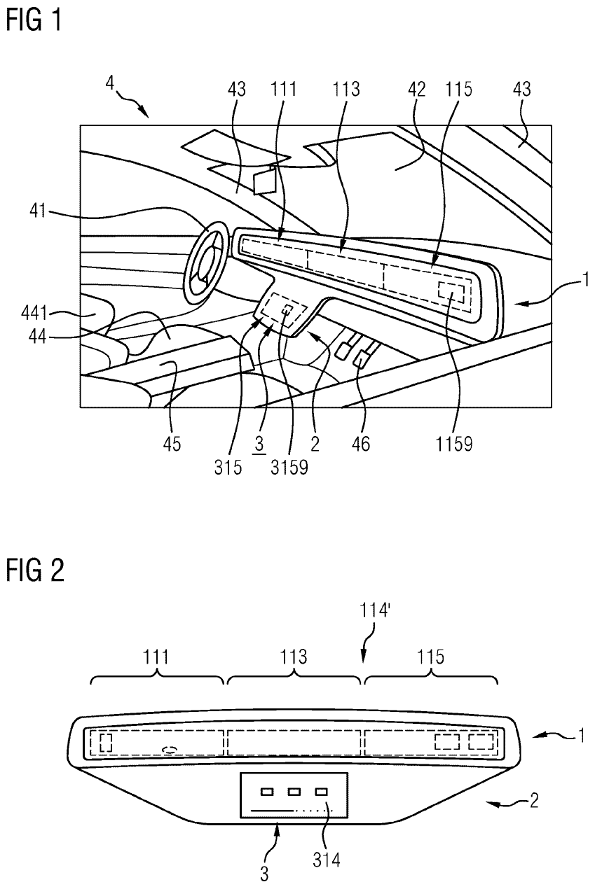

FIG. 1 shows a display apparatus according to the invention. The main display element 1 for high-resolution display can be seen. It is arranged between the steering wheel 41 and the windscreen 42 of a motor vehicle 4. The main display element 1 extends over almost the entire width of the motor vehicle 4, from the left to the right A-pillar 43. The A-pillar 43 is often also referred to as the pillar. A driver's seat 44, a central armrest 45 and pedals 46 can also be seen.

Slightly beneath the main display element 1 and arranged at an angle relative thereto there is a disappearance technology control panel 2 with a selection display element 3. The disappearance technology control panel 2 projects into the interior of the motor vehicle 4. The selection display element 3 has a touch function. That is to say, it is able to detect touches by a user or even simply the approach, for example of a finger of the user, assign them to a specific region of its surface and thus use them as an input signal. The selection display element 3 has a display with a lower resolution than the main display element 1. In the exemplary embodiment shown here, it has a lower color resolution in which only a small number of different colors are used, here white and orange. In other exemplary embodiments, even only a single-color display is provided. The main display element 1, by contrast, has a full-color display with a large color space. In other exemplary embodiments, the display of the selection display element 3 has a lower spatial resolution than the main display element 1.

The selection display element 3 has a smaller spatial extent in the horizontal direction than the main display element 1.

A disappearance technology control panel is to be understood as being a surface behind which there are arranged at least one display element and at least one operator input element, which are not recognizable as such at least in the switched-off state. Only in specific situations is information that is displayed by the display element visible through the surface and can input commands be inputted by touching specific regions of the surface. A disappearance technology control panel is therefore often also referred to as an invisible control panel.

In the automotive sector, but also in household appliances and in other areas of application, there is an observable trend toward such disappearance technology control panels, that is to say that operating or display functions should be as invisible as possible in the switched-off state in order to achieve a reduced design with smooth, generous surfaces. Technical elements should be visible only when they are needed. Such disappearance technologies are known, for example, under the names “Shytech” or “Camouflage”.

To realize disappearance technology, a display panel can be arranged behind a design surface, for example. Transmissive, decorative surfaces suitable for this application can be produced in particular in plastics or glass technology. The decoration is applied by printing technology onto the surface of a cover panel or alternatively onto a separate film surface. The decoration can be applied, for example, as a transmissive print or in the form of a perforated mask.

The main display element 1 has such a horizontal extent and extends in respect of a designated viewing position 441 on the driver's seat 44 so far to the right that a viewer is not able to reach every part of the display area of the main display element 1 with one of his fingers from the designated viewing position 441. The selection display element 3, by contrast, has such an extent and is arranged in respect of the designated viewing position 441 so close to the viewer that this viewer is able to reach every part of the display surface of the selection display element 3 with one of his fingers from the designated viewing position 441. The selection display element 3 is easy to reach both for a driver and for a passenger as the viewer.

The main display element 1 shown is a curved, very wide display element (also referred to as an ultrawide display). It extends over the entire width of the cockpit and with its avant-garde display design creates a new dimension for the user experience. The innovative control concept based on the disappearance technology control panel 2 ensures more safety and comfort.

In the central region of the main display element 1, which is located above the disappearance technology control panel 2, a display window 113 containing navigation instructions is currently displayed in the figure. To the left thereof, in front of the viewing position 441 of a driver, a display window 111 containing information about the current driving status is shown, similar to that displayed in a conventional combination instrument. On the far right there is shown a display window 115 displaying available audio content as well as audio content that is currently being played.

In the selection display window 3, a representation 315 of the display window 115 containing audio contents is displayed with a reduced resolution. A symbol 3159 with reduced resolution contained in this representation 315, said symbol corresponding to a symbol 1159 with higher resolution of the display window 115, serves for the selection of the audio content represented by the symbol 1159.

FIG. 2 shows a display apparatus according to one aspect of the invention. The main display element 1 has a similar configuration to that described above. On this display element there are shown on the left a display window 111 containing information about the current driving status, in the middle a display window 113 containing video contents, and on the right a display window 115 containing audio contents.

The disappearance technology control panel 2 is here wider than shown in the preceding figure and merges with a curved shape into the main display element 1. To the left and right of the selection display element 3 it has larger areas without a display function. In a development of the invention that is not shown here, display elements and/or control elements are also arranged beneath one or beneath both of these areas, and said elements can be configured both in disappearance technology and in conventional form. On the selection display element 3 there is shown a representation 314 for an audio-video communication control. By a long press on the representation 314 by a user, the command to display a display window 114 on the main display element 1 is issued. In the example shown, it is inserted between the display windows 113 and 115, as indicated by the arrow identified by reference sign 114′. To this end, the width of all or of at least one of the display windows 111, 113, 115 is reduced, and a display window that is not shown here is displayed between the display windows 113 and 115.

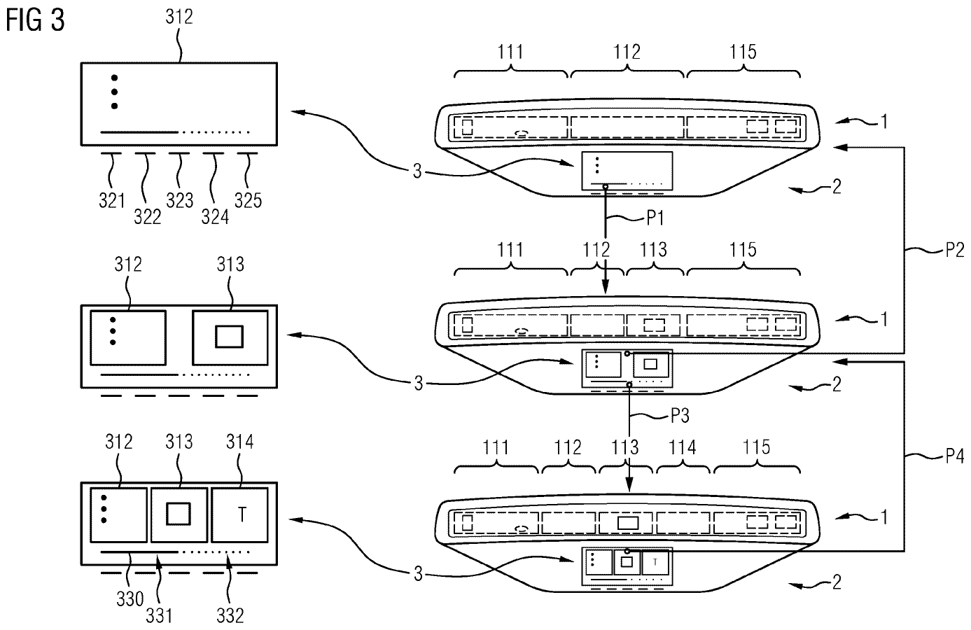

FIG. 3 shows a display apparatus according to one aspect of the invention similar to FIG. 2. In the right-hand part of the figure, the display apparatus is shown in three successive states. On the left-hand side, the respective selection display window 3 is shown in an enlarged representation and with changed coloring (black lines on the left instead of lighter lines on the right) for better recognizability.

In the upper of the three successive states, there are arranged side by side on the main display element 1 three display windows 111, 112, 115 of approximately equal width: a display window 111 containing information about the current driving status, a display window 112 containing navigation information, and a display window 115 containing audio contents. The selection display window 3 is shown in enlarged form on the left. It shows a representation 312 of the display window 112 containing navigation information. In the representation, a list of waypoints of the navigation, symbolized by large dots, is shown. Beneath the representation 312, five selection regions 321-325 are shown by horizontal lines. Selection region 321 is assigned a representation 311 for “Media”, selection region 322 is assigned the representation 312 containing navigation information, and selection region 324 is assigned a representation 314 for “Climate”. If the user selects selection region 321 by touching it for a prolonged time period, he reaches the middle of the three successive states. This is indicated by arrow P1.

In the middle state of the three successive states, the two outer display windows 111 and 115 of the main display element 1 retain their horizontal extent compared to the preceding state. By contrast, the display window 112 containing navigation information that was originally in the middle has been compressed horizontally and has freed up an area on the right on which a display window 113 containing information about available media is now displayed. These media may be a hard drive installed in the vehicle, a removable storage medium which can be connected to the vehicle, a memory of a mobile device that is connected wirelessly to the vehicle, or another medium. On the selection display window 3 shown in enlarged form on the left, the size of the representation 312 for navigation is reduced horizontally and said representation is arranged on the left, while a representation 313 for media is arranged on the right. The selection display element 3 has thus been split for these two representations 312, 313. The information about “Media” is symbolized in the figure by a square. If the user wishes to remove the display window 113 from the main display element 1 again, he inputs a corresponding command via the representation 313. This can be carried out, for example, by double-tapping the representation 313 or by a long press on the selection region 321. The display apparatus then returns to the upper of the three states, which is indicated by an arrow P2. By contrast, if the user wishes a further display window 114 containing information about the air conditioning of the vehicle to be displayed on the main display element 1, he selects this by touching the selection region 324 for “Climate” for a prolonged time period. The lower of the three successive states is thus reached. This is indicated by arrow P3.

In the lower of the three states shown, the two outer display windows 111 and 115 are slightly compressed horizontally compared to the two states shown thereabove. The two display windows 112 and 113 are also compressed slightly more than in the middle of the states shown and have been moved further to the left. A display window 114 containing information about the air conditioning of the vehicle is now displayed on the area which has been freed up between the display windows 113 and 115. On the selection display window 3 shown in enlarged form on the left, the size of the representation 312 for navigation and of the representation 313 for media is reduced horizontally and said representations are displaced to the left, while a representation 314 for climate is arranged on the right. The selection display element 3 has thus again been split for these three representations 312, 313, 314. The representation for “Climate” is symbolized in the figure by a letter “T”, which stands for temperature. Here too, the user can remove the display window 114 for climate information from the main display element 1 again by inputting a corresponding command via the representation 314. The display apparatus then returns to the preceding state, which is indicated by an arrow P4.

A selection bar 330 is shown in the lower region of the selection display element 3. The selection bar has a solid line 331 in its left-hand region and a dotted line 332 in its right-hand region. The selection bar 330 serves for the acceptance of further commands. For example, this may be the control of a volume. Touching and dragging the solid line 331 to the left reduces the volume. The dotted line 332 becomes correspondingly longer. Dragging to the right increases the volume. According to another example, the arrangement of the representations 311-315 can be changed by dragging the solid line. Other functions are also expediently conceivable here.

It will be seen that the display windows 112, 113, 114, which are arranged in the main display element 1 between a display window 111 shown on the far left and a display window 115 shown on the far right, are displayed on the main display element 1 in accordance with the representations 312, 313, 314 assigned thereto in the selection display element 3, that is to say in the same order. In alternative configurations, it is provided that the order in which the display windows 112, 113, 114 are displayed is different from that of the representations 312, 313, 314 assigned thereto. For example, it can be provided that a display window 112 for navigation is always displayed as close to the driver as possible. This has the advantage that the driver is able to see this display window without having to look too far away from the driving direction. By contrast, the associated representation 312 in this example is always displayed in the middle of the selection display element 3. This has the advantage that both the driver and the passenger are easily able to reach the representation 312 with their finger for operation.

In a variant of a method according to the invention, the selection display element 3 is operated without a main display element 1. The selection display element 3 here serves both for selection and for display. The representations 31n thus represent the display windows in which information is displayed. The image elements shown therein are displayed in less highly simplified form in this variant than in the left-hand part of FIG. 3, in order to provide the user with as high-quality a representation as possible. The selection display elements 3 shown in the left-hand part of FIG. 3 thus show a simplified representation of a selection display element 3 of this variant.

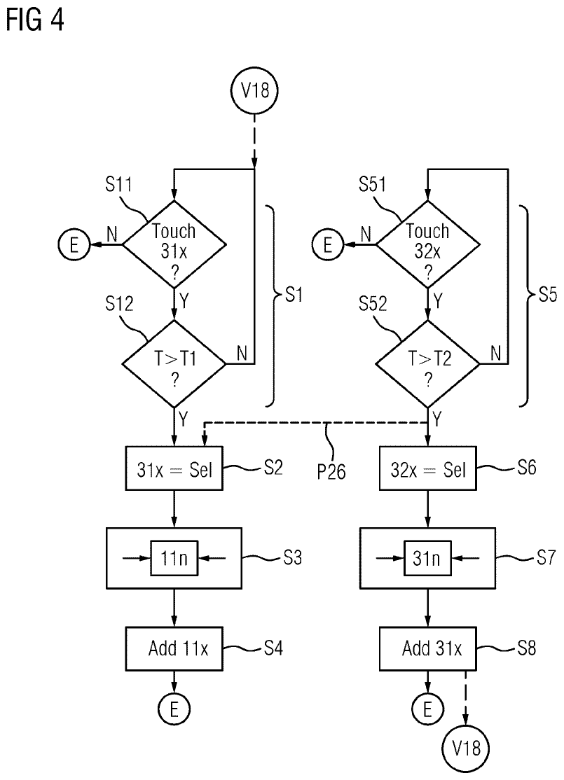

FIG. 4 shows on the left-hand side a method according to one aspect of the invention for operating a display apparatus. The main display element 1 is here adapted to display a plurality of display windows 11x (here: x=1, . . . , 5) side by side, and the selection display element 3 is adapted to display a plurality of small representations 31x (here: x=1, . . . , 5) of display windows 11x which can be displayed on the main display element 1. The method includes the following steps:
Detecting S1 whether a touch of one of the representations 31x lasts for a longer time period T than a given first minimum time period T1. This is represented in the figure by a touch detection S11 and a size comparison S12. If the result of the touch detection S11 is negative, this method ends E. Otherwise, the method branches to the size comparison S12. If the result thereof is negative, the method returns to the touch detection S11, otherwise to the next step S2.
Classifying S2 the corresponding representation 31x as the selected representation (Sel.).
Reducing the size S3 of at least one of the display windows 11n currently displayed on the main display element 1. This is indicated in the figure by vertical compression in the horizontal direction.
Displaying S4 a display window 11x corresponding to the selected representation 31x on the area of the main display element 1 that has been freed up by the reduction in size. This method then ends E. After the end E of a method, the method can be carried out again, or it is also possible for a different method to be carried out first.

FIG. 4 shows on the right-hand side a method for operating a display apparatus, wherein the selection display element 3 is adapted to display a plurality of representations 31x (here: x=1, . . . , 5) side by side. The method includes the following steps:
Detecting S5 whether a touch of a selection region 32x assigned to a representation 31x lasts for a longer time period T than a given second minimum time period T2. This is represented, as described in relation to step S2, by a touch detection S51 and a size comparison S52.
Classifying S6 the corresponding selection region 32x as the selected selection region.
Reducing the size S7 of at least one of the representations 31n currently displayed on the selection display element 3.
Displaying S8 the selected representation 31x on the area of the selection display element 3 that has been freed up by the reduction in size.

The method shown on the right-hand side of this figure is also used, for example, in a variant in which the selection display element 3 is operated without a main display element 1.

According to an optional aspect variant, both step S6 and the following steps and step S2 and the following steps are carried out after a positive result of step S52. This is indicated by an arrow P26. Thus, both the main display element 1 and the selection display element 3 are split for the addition of a further display window 11x and a further representation 31x, respectively. According to another optional embodiment variant, steps S5 to S8 are first carried out. Multiple selection options are thus available to the user on the selection display element 3. The selection thereof for display on the main display element 1 is then carried out by steps S1 to S4. Branching from step S8 to step S1 is indicated by the arrows P18 and the connecting points V18.

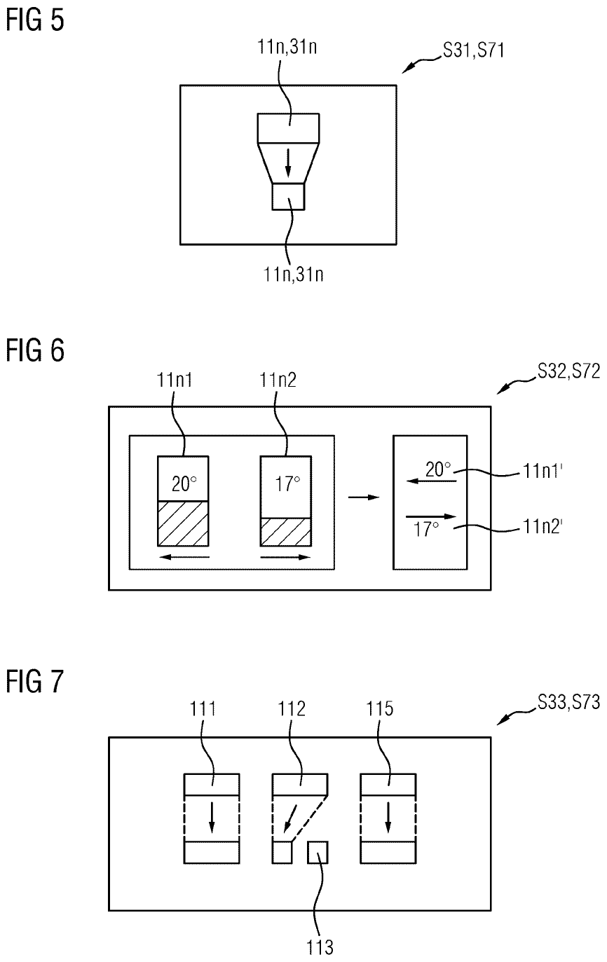

FIG. 5 shows a further method step: reducing the size S31, S71 of a display window 11n currently displayed on the main display element 1, or of a representation 31n currently displayed on the selection display element 3, wherein the vertical extent thereof is retained and the horizontal extent thereof is reduced. The contents displayed in the display window 11n or in the representation 31n are compressed, for example, in the corresponding ratio.

FIG. 6 shows a further method step: in the case where the size of a display window 11n or of a representation 31n is reduced S3, S7 to below a given minimum size: replacing S32, S72 at least one of the image elements 11n1, 11n2 displayed in that display window 11n or in that representation 31n by a placeholder image element 11n1′, 11n2′ of reduced complexity. For example, graphic bar displays 11n1 for the left-hand half of the vehicle and 11n2 for the right-hand side of the vehicle are replaced by in each case a numerical temperature display 11n1′, 11n2′, which are arranged one above the other. This is also an example of how the relative arrangement of image elements can be changed: The image elements 11n1, 11n2 are initially arranged side by side, as shown in the left-hand part of the figure. After the reduction in size, the corresponding placeholder image elements 11n1′, 11n2′ are arranged one above the other, as shown in the right-hand part of the figure.

FIG. 7 shows a further method step: reducing the size S33, S73 of different display windows 11n or representations 31n to different extents. An area for displaying a further display window 113 is thus created.

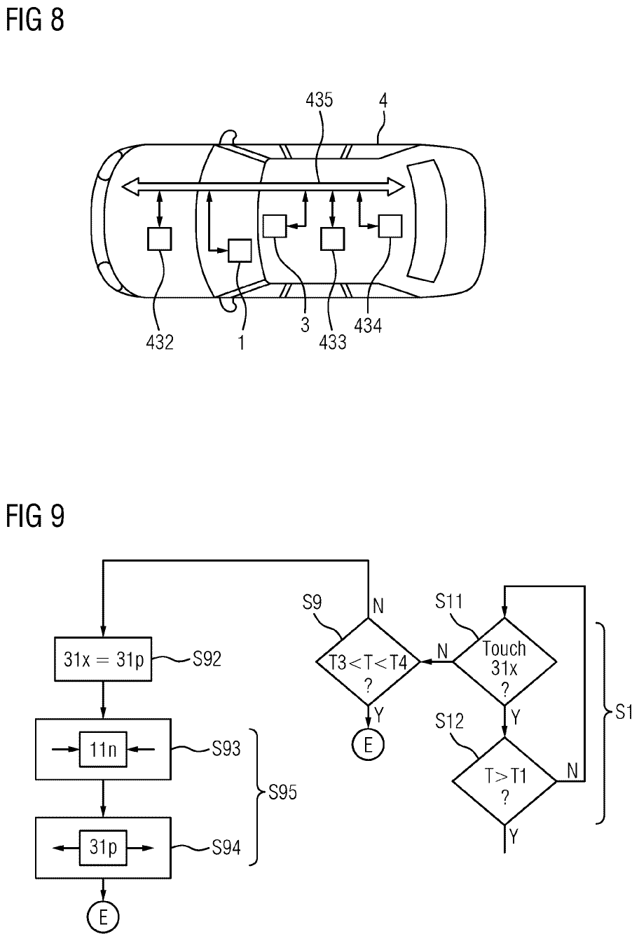

FIG. 8 schematically shows a motor vehicle 4 that utilizes a display apparatus according to the invention with a main display element 1. The motor vehicle 4 is a passenger car in this example. In this example, the main display element 1 is arranged in a dashboard. Selection information is accepted by the selection display element 3. Data relating to the vehicle environment can be acquired by way of a sensor system (not shown). This sensor system may in particular comprise environment recognition sensors, for example ultrasound sensors, laser scanners, radar sensors, lidar sensors or cameras. The information acquired by this sensor system can be used to generate contents to be displayed for the display apparatus. In this example, further components of the motor vehicle 4 are a control device 432 and a data transfer unit 433. A memory 434 is present for storing data. The control device 432 serves, for example, as a computer by which instructions of a computer program are executed, said instructions causing the control device 432 to carry out a method according to the invention. By the control device 432, information is read from the memory 434, inter alia, in order to take suitable account of priority image elements 11n1″, 11n2″ and subordinate image elements 11n1′″, 11n2′″ in the size reduction or enlargement. Placeholder image elements 11n1′, 11n2′ are also taken from the memory 434 by the control device 432. Information about the type of a display window is also stored in the memory 434. Such a type concerns, for example, a type of display window that may be compressed by not more than up to a given percentage. Another type of display window may be removed from the main display element only if specific conditions are present, for example a user authorization. By the data transfer unit 433 it is possible, for example, to establish a connection with a backend, for example in order to acquire updated software for components of the motor vehicle or updated image elements 11n1, 11n2 or updated information relating to such image elements 11n1, 11n2, and to store them in the memory 434 or supply them to a suitable component. Data is exchanged between the various components of the motor vehicle via a network 35.

FIG. 9 shows sub-steps of a method according to the invention for operating a display apparatus, similar to that shown in FIG. 4. Steps S1, S11 and S12 correspond to those shown therein. These are followed at the bottom by further steps, which is indicated here by three dots. If the result of the touch detection S11 is negative, it is detected S9 whether one of the representations 31x or a selection region 32x assigned to a representation 31x has been touched for a short, uninterrupted time period T, where T3<T<T4. If that is the case, the corresponding representation 31x is classified S92 as the representation selected as priority 31p. One or more display windows 11n or representations 31x that are currently being displayed are then replaced S95 by the display window 11p assigned to the representation selected as priority 31p or, as symbolized here, by the representation selected as priority 31p. This is shown in two steps in the figure: First of all, one or more display windows 11n or representations 31n are reduced S93. For replacement, the reduction S93 corresponds to a horizontal compression to width zero. In addition or alternatively, compression can also be carried out to a very small value, so that optionally only a narrow placeholder image element remains. The representation selected as priority 31p is then enlarged S94.

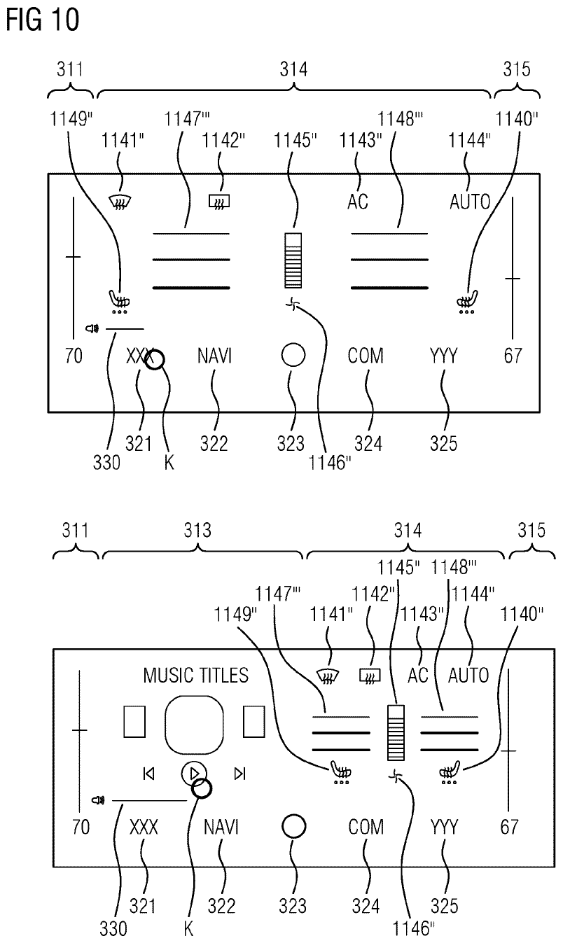

FIG. 10 shows displayed states of a selection display element 3. A first, earlier state is shown in the upper region of the figure, and a subsequent state is shown in the lower region. A narrow representation 311 can be seen on the left, and a representation 315 that is likewise narrow can be seen on the far right. These are temperature controllers for the left and right sides of a motor vehicle. Between these representations 311, 315 there is shown a wide representation 314 for climate. In the lower region of the selection display element 3 there are selection regions 321-325. A selection bar 330 is located above the selection regions 321-325.

In the representation 314 for climate, an image element 1141″ for windscreen heating, an image element 1142″ for rear window heating, an image element 1143″ for air conditioning and an image element 1144″ for automatic operation are arranged side by side in a top row. In the middle of the representation 314 for climate there is an image element 1145″ for indicating the fan speed, and beneath that image element there is an image element 1146″ symbolizing a fan. On the left and right of the image elements 1145″ for indicating the fan speed there are image elements 1147′″, 1148′″ for indicating the temperature in the left and right region, respectively, of the passenger compartment. In the bottom left corner of the representation 314 for climate there is an image element 1149″ for the seat heater on the left and in the bottom right corner there is an image element 1140″ for the seat heater on the right. All the image elements apart from the image elements 1147″′ and 1148″′ are priority elements.

A circle K indicates the position of a finger of a user. This is located in the selection region 321 for media playback. Once the finger has been held in the selection region 321 for a prolonged time period, a representation 313 for media is displayed on the selection display element 3. To this end, the representation 314 for climate is compressed horizontally. However, the contents displayed by the image elements 1140″-1149″ are not compressed horizontally according to the external dimensions of the representation 314 but instead are treated differently according to their priority. The image elements arranged in the top row are priority image elements 1141″-1144″ and remain unchanged in terms of their size and their length-to-width ratio, but they move closer to one another. The image elements 1145″ and 1146″ are also priority image elements, remain unchanged in terms of their size and their length-to-width ratio and also retain their position in the middle of the representation 314. The image elements 1147″′ and 1148″′ are subordinate and are compressed horizontally and vertically. The image elements 1149″ and 1140″ are priority image elements, remain unchanged in terms of their size and their length-to-width ratio, but they change their relative position with respect to the other image elements and are now located in the middle beneath the image elements 1147″′ and 1148″′. The image elements present in the representation 313 will not be discussed in greater detail here. It will be seen that the circle K, which indicates the position of a finger of a user, is located in the region of the representation 313 for media playback.

The subordinate image elements 1147″′ and 1148″′ are thus compressed both horizontally and vertically as they move from the upper part of the figure to the lower part representing a later point in time. The priority image elements 1149″ and 1140″ are changed in their relative arrangement. Initially, they are arranged laterally offset relative to the image elements 1147″′ and 1148″′; subsequently, they are beneath those image elements 1147″′ and 1148″′.

In a preferred embodiment, the main display element 1 has a width of 1.29 meters and reaches from one A-pillar to the other. It has a 47.5-inch TFT display, which is illuminated by more than 3000 light-emitting diodes on an active surface with a size of 7680 by 660 pixels. The matrix background lighting not only produces an excellent image quality with high contrast, but also offers the possibility of dimming individual screen regions that are not needed. Local dimming technology saves electricity and improves readability. The very wide main display element 1 is the driver, central and passenger screen in one and offers designers the greatest possible freedom to design the cockpit in a futuristic and premium manner and to play content on the seamless screen area. The control concept based on a disappearance technology control panel 2 with the selection display element 3, which changes into a high-contrast, clearly visible display, allows for comfortable and safe interaction. Control takes place with a focus on what is important. Interaction with the main display element 1 takes place with the aid of the integrated disappearance technology control panel 2, which appears, as if by magic, only when it is needed. This solution prevents superfluous information from distracting the driver. Regions that are outside arm's reach of the user can also comfortably be controlled via the disappearance technology control panel 2. Haptic feedback from the disappearance technology control panel 2 allows the main display element 1 to be controlled without having to look away from the road. The selection display element 3 is concealed behind a semi-transparent surface, which seamlessly integrates the screen of the selection display element 3 optically and haptically into the surroundings. If the selection display element 3 is not needed, it is invisible. However, it does not then appear as an empty black area but merges with the decorative surface to form a unit, irrespective of whether the design is of wood, carbon or another high-quality surface. Moreover, special matrix background lighting is used. This lighting technology allows contents to be displayed in any light situation with the necessary brightness and with as high a contrast as possible, without a visible background, the so-called “postcard effect”. The combination of the selection display element 3 designed with disappearance technology and the very wide main display element 1 is unique, because it answers the question of how the growing screens in the cockpit remain operable. Especially display screens that extend from A-pillar to A-pillar present the challenge of finding operating solutions with which the driver and the passenger reach the entire screen. The seamlessly integrated display control panel, the selection display element 3, within reach of the driver solves this problem in an extremely elegant manner and at the same time accommodates the wish of many drivers to operate display screens by touch control.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. A display apparatus comprising:
a main display element for high-resolution display; and
an invisible control panel having a selection display element with touch function which has a lower resolution than the main display element.

18. The display apparatus as claimed in claim 17, wherein the main display element is a display element that displays in color, and the selection display element is a display element that displays with a lower color resolution or in one color.

19. The display apparatus as claimed in claim 17, wherein the selection display element has a smaller extent than the main display element and/or wherein the selection display element is arranged beneath the main display element.

20. The display apparatus as claimed in claim 17, wherein:
the main display element has such an extent and is so arranged with respect to a designated viewing position that a viewer is not able to reach every part of a display area of the main display element with one of his fingers from the designated viewing position, and
the selection display element has such an extent and is so arranged with respect to a designated viewing position that a viewer is able to reach every part of the display area of the selection display element with one of his fingers from the designated viewing position.

21. The display apparatus as claimed in claim 17, further comprising:
a control device; and
a memory in which information about priority image elements or about priority and subordinate image elements is stored.

22. A method for operating a display apparatus having a main display element for high-resolution display and an invisible control panel having a selection display element with touch function which has a lower resolution than the main display element, wherein the main display element is adapted to display a plurality of display windows side by side, and the selection display element is adapted to display a plurality of small representations of display windows that can be displayed on the main display element, the method comprising:
detecting whether a touch of one of the representations lasts for a longer time period than a given first minimum time period;
classifying a corresponding representation as the selected representation;
reducing a size of at least one of the display windows currently displayed on the main display element; and
displaying a display window corresponding to the selected representation on an area of the main display element that has been freed up by the reduction in size.

23. A method for operating a display apparatus having a main display element for high-resolution display, and an invisible control panel having a selection display element with touch function which has a lower resolution than the main display element, wherein the selection display element is adapted to display a plurality of representations side by side, the method comprising:
detecting whether touching of a selection region assigned to a representation lasts for a longer time period than a given second minimum time period;
classifying a corresponding selection region as the selected selection region;
reducing a size of at least one of the representations currently displayed on the selection display element; and
displaying the representation corresponding to the selected selection region on an area of the selection display element that has been freed up by the reduction in size.

24. A method for operating a display apparatus having a selection display element which has a plurality of selection regions and is adapted to display a plurality of representations side by side, the method comprising:
detecting whether touching of a selection region assigned to a representation lasts for a longer time period than a given second minimum time period;
classifying a corresponding selection region as the selected selection region;
reducing a size of at least one of the representations currently displayed on the selection display element; and
displaying a representation corresponding to the selected selection region on an area of the selection display element that has been freed up by the reduction in size.

25. The method for operating a display apparatus as claimed in claim 22, wherein, for reducing the size of a display window currently displayed on the main display element, or of a representation currently displayed on the selection display element, a vertical extent thereof is retained and a horizontal extent thereof is reduced.

26. The method for operating a display apparatus as claimed in claim 22, wherein, when the size of a display window or of a representation is reduced to below a given minimum size, at least one of the selection display elements displayed in that display window or that representation is replaced by a placeholder image element of reduced complexity or is removed from the display completely.

27. The method for operating a display apparatus as claimed in claim 22, wherein, when the size of the display window or of the representations is reduced, the size of different display windows or representations is reduced to different extents.

28. The method for operating a display apparatus as claimed in claim 22, wherein priority image elements and subordinate image elements are specified, and wherein, when the size of a display window or of a representation is reduced, the priority image elements displayed in that display window or in that representation retain their length-to-width ratio and/or their size, and at least one of the subordinate image elements is compressed in at least one direction or is replaced by a placeholder image element of reduced complexity or is removed from the display completely.

29. The method for operating a display apparatus as claimed in claim 22, further comprising:
detecting whether one of the representations or a selection region assigned to a representation is touched for a short, uninterrupted time period;
classifying the corresponding representation as the representation selected as priority; and
replacing one or more display windows or representations that are currently being displayed by the display window assigned to the representation selected as priority or by the representation selected as priority.

30. The method for operating a display apparatus as claimed in claim 22, wherein a relative arrangement of image elements with respect to one another is changed when the size is reduced.

31. The method for operating a display apparatus as claimed in claim 22, wherein the display window or the plurality of display windows arranged between a display window displayed on a far left and a display window displayed on a far right is displayed on the main display element in accordance with the representation or the plurality of representations assigned thereto.

32. A computer program stored on a nontransitory medium, containing instructions which, when executed by a computer, cause the computer to carry out a method for operating a display apparatus having a main display element for high-resolution display and an invisible control panel having a selection display element with touch function which has a lower resolution than the main display element, wherein the main display element is adapted to display a plurality of display windows side by side, and the selection display element is adapted to display a plurality of small representations of display windows that can be displayed on the main display element, the method comprising:
detecting whether a touch of one of the representations lasts for a longer time period than a given first minimum time period;
classifying a corresponding representation as the selected representation;
reducing a size of at least one of the display windows currently displayed on the main display element; and
displaying a display window corresponding to the selected representation on an area of the main display element that has been freed up by the reduction in size.
